(19) United States
(12) Patent Application Publication
(10) Pub. No.: US 2026/0171108 A1
(43) Pub. Date: Jun. 18, 2026

(54) METHOD AND APPARATUS FOR DETECTING SPEECH TERMINATION

(71) Applicants: HYUNDAI MOTOR COMPANY, Seoul (KR); KIA CORPORATION, Seoul (KR)

(72) Inventors: Yoon Jung Lee, Hwaseong-si (KR); Young Jae Park, Hwaseong-si (KR)

(73) Assignees: HYUNDAI MOTOR COMPANY, Seoul (KR); KIA CORPORATION, Seoul (KR)

(21) Appl. No.: 19/319,491

(22) Filed: Sep. 4, 2025

(30) Foreign Application Priority Data
Dec. 18, 2024 (KR) 10-2024-0190299

(51) Int. Cl. G10L 25/78

(52) U.S. Cl. CPC G10L 25/78; G10L 2025/786

(57) ABSTRACT

A method and apparatus detect speech termination. A computer implemented method for determining whether a speech utterance is terminated includes receiving an utterance of a user. The method further includes dynamically adjusting a length of a trailing silence interval for the user based on a type of a last word unit in the utterance of the user. The method also includes determining whether the utterance of the user is terminated based on an additional utterance being received within the adjusted trailing silence interval.

### CROSS-REFERENCE TO RELATED APPLICATION

This application claims the benefit of and priority to Korean Patent Application No. 10-2024-0190299, filed in the Korea Intellectual Property Office on Dec. 18, 2024, the entire disclosure of which is incorporated herein in its entirety by reference.

### TECHNICAL FIELD

The present disclosure relates to a method and an apparatus for detecting speech termination.

### BACKGROUND

The content described in this section merely provides background information related to the present disclosure and does not constitute prior art.

Conventional speech recognition systems are operated by terminating speech input when it is determined that there is no user input for a certain period of time. In general, if the elapsed time during which a speech signal remains below a certain threshold exceeds a certain period of time, conventional speech recognition systems consider that the speech signal is trailing silence and the speech input is terminated.

Conventional methods are problematic since the length of a fixed trailing silence is used. Therefore, users' speech characteristics are not considered. For example, a speech recognition rate may vary depending on the speed at which the user speaks or the length of space between word units. For users who speak slowly, speech input may be terminated by conventional speech recognition systems even though an utterance has not yet finished. Conversely, for users who speak quickly, unnecessary waiting times may occur after the utterance ends.

Conventional methods of using the length of fixed trailing silence that do not sufficiently consider the flow of speech or a speaker's intended meaning have technical problems since speech input may terminate prematurely even when the user intends to form a complete sentence by making additional utterances.

### SUMMARY

The disclosed embodiments provide a technical solution to improve the accuracy of speech recognition by dynamically adjusting the length of a trailing silence interval in consideration of the user's speech pattern and intention.

In particular, the disclosed embodiments prevent premature termination of a speech recognition mode and reduce unnecessary waiting time by dynamically adjusting the length of an appropriate trailing silence interval based on the results of morphological analysis of a user's utterance.

The objectives to be achieved by the present disclosure are not limited to the above-mentioned objectives. Other objectives not explicitly mentioned should be apparent to those of ordinary skill in the art from the following description.

An embodiment of the present disclosure provides a method for determining whether a speech utterance is terminated. The method includes receiving an utterance of a user. The method further includes dynamically adjusting a length of a trailing silence interval for the user based on a type of last word unit in the utterance of the user. The method also includes determining whether the utterance of the user is terminated based on an additional utterance being received within the adjusted trailing silence interval.

Another embodiment of the present disclosure provides an apparatus for determining whether a speech utterance is terminated. The apparatus includes at least one memory. The apparatus further includes at least one processor. The at least one processor is configured to execute commands to receive an utterance of a user. The at least one processor is further configured to dynamically adjust a length of a trailing silence interval for the user based on a type of last word unit in the utterance of the user. The at least one processor is further configured to determine whether the utterance of the user is terminated based on an additional utterance being received within the adjusted trailing silence interval.

Unlike conventional speech recognition systems that apply a fixed or threshold-based trailing silence interval, the present disclosure utilizes syntactic context analysis based on real-time part-of-speech information. By dynamically adjusting the trailing silence interval based on the grammatical nature of the last word unit in the user's utterance and by referencing a predefined list of representative commands, the present disclosure provides a technical solution and achieves improved speech recognition performance. This dynamic adjustment significantly differs from and improves upon current fixed-interval or static threshold methods.

### BRIEF DESCRIPTION OF THE DRAWINGS

FIG. 1 is a block diagram schematically illustrating a speech utterance termination detection device according to an embodiment of the present disclosure.

FIG. 2 is a block diagram schematically illustrating a controller according to an embodiment of the present disclosure.

FIG. 3 is a flowchart illustrating the operation of a speech utterance termination detection device according to an embodiment of the present disclosure.

FIG. 4 is a block diagram schematically illustrating a computing device that may be used to implement a method or apparatus according to the present disclosure.

### DETAILED DESCRIPTION

Hereinafter, various embodiments of the present disclosure are described below in detail with reference to the accompanying drawings. In the following drawings, the same reference numerals are used throughout to designate the same or equivalent elements, even though the elements are shown in different drawings. Further, in the following description of various embodiments, a detailed description of well-known functions and configurations incorporated therein has been omitted for the purpose of clarity and for brevity.

Additionally, various terms such as first, second, A, B, (a), (b), and the like, are used solely to differentiate one component from the other but not to imply or suggest the type, order, or sequence of the components. Throughout this specification, when a part ‘includes’ or ‘comprises’ a component, it is understood that the part may include other components unless specifically stated to the contrary. When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

The following detailed description, together with the accompanying drawings, is intended to describe various embodiments of the present disclosure and is not intended to limit the scope of the present disclosure to the embodiments described herein.

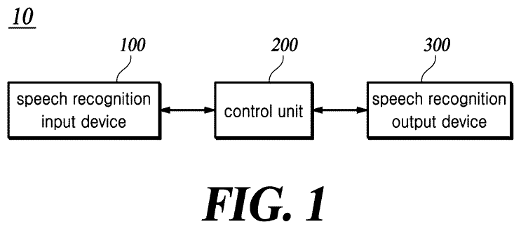

FIG. 1 is a block diagram schematically illustrating a speech utterance termination detection device 10 according to an embodiment of the present disclosure.

The speech utterance termination detection device 10 according to an embodiment of the present disclosure may include all or some of a speech recognition input device 100, a controller 200, and a speech recognition output device 300. Components illustrated in FIG. 1 represent functionally distinct elements. One or more components may be implemented to be integrated with each other in an actual physical environment.

The speech recognition input device 100 is a device that collects speech utterances uttered by a speaker. The speech recognition input device 100 may include a microphone or other speech collection sensors. The speech recognition input device 100 may convert collected speech data into a digital signal to generate speech data for subsequent processing. The speech recognition input device 100 may further include a filtering function to remove noise from the surrounding environment or to refine a speech signal.

The controller 200 may analyze speech data and determine the termination, i.e., end, of the speaker's utterance. The controller 200 may perform the morphological analysis of the speech data and the tagging of the part of speech. The controller 200 may dynamically adjust the length of a trailing silence interval based on the analyzed information. The term “length of a trailing silence” refers to a length of time during which a speech signal remains below a certain threshold after the speaker's speech utterance. The length of the trailing silence interval may be adjusted depending on the semantic characteristics of the utterance, such as the type of the final word unit, the possibility of further utterances, and the like. The controller 200 may learn and apply personalized characteristics such as the speaker's utterance speed and pattern as needed.

The speech recognition output device 300 may include a display, a speaker, an LED notification device, and the like. The speech recognition output device 300 may interact with the user by visually displaying a recognized speech text or outputting feedback speech. Further, the status of the speech recognition mode, such as activation, standby, or termination, may also be intuitively transmitted using the LED notification device, and the like. The speech recognition output device 300 may provide status notifications and additional information related to speech recognition results to improve the user experience as needed or may provide composite feedback in conjunction with other devices.

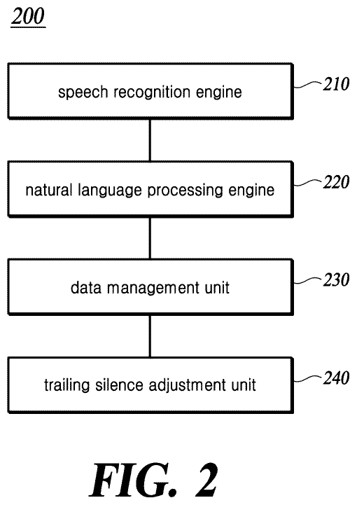

FIG. 2 is a block diagram schematically illustrating the controller 200 according to an embodiment of the present disclosure.

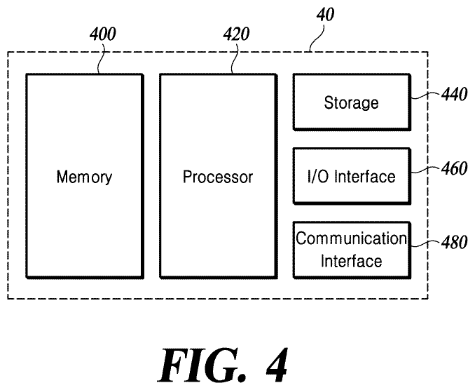

The controller 200 according to an embodiment of the present disclosure may include all or some of a speech recognition engine 210, a natural language processing engine 220, a data management unit 230, and a trailing silence adjusting unit 240. One of ordinary skill in the art should appreciate that one or more engines or units, e.g., the controller including the speech recognition engine 210, the natural language processing engine 220, the data management unit 230, and the trailing silence adjusting unit 240 described herein may be implemented using, among other things, a tangible computer-readable medium or non-transitory memory comprising computer-executable instructions (e.g., executable software code) executed by specifically configured hardware or processors, e.g., one or more processors 420 described in more detail with respect to FIG. 4. It should be appreciated that the disclosed embodiments may be implemented as a different or separate module of the speech utterance termination detection device 10, or a separate computer system coupled with the speech utterance termination detection device 10.

The speech recognition engine 210 acquires the speech utterance of a speaker received by a microphone in a vehicle and converts the speech utterance into text using an STT (Speech to Text) engine. The STT engine may convert a speech signal into text by applying a speech recognition algorithm or deep learning model to the speech signal. The speaker's speech utterance is a speech signal, and the speech recognition engine 210 receives a speech signal corresponding to the speaker's speech utterance.

The natural language processing engine 220 may understand and identify a speaker's speech utterance by classifying the intended meaning and slot of the speaker's speech utterance. The speaker's intended meaning may be classified into one of several categories, such as making a phone call, searching for a destination, playing a radio broadcast, providing route guidance, or playing a song. The speaker's intended meaning may be classified into various domains such as changing the destination, adding a stopover, changing a stopover, or making a phone call, an out-of-domain (OOD) command.

The slot means an object required to provide information according to the speaker's intended meaning. The slot may be defined in advance for each intended meaning. For example, the slot for a route setting intent may be a destination or a stopover. A keyword corresponding to the slot may be home or work.

The natural language processing engine 220 may extract information such as domains, entity names, and speech acts from an input sentence using, for example, a Natural Language Understanding (NLU) engine, and extract the intent and slot based on the extracted result.

The domain is information for identifying the subject of a speaker's speech utterance. For example, domains representing various subjects such as vehicle control, information provision, text transmission, and navigation functions may be determined based on the input sentence.

The entity name represents proper nouns such as people's names, place names, organization names, times, dates, and currencies. Named entity recognition (NER) is the task of identifying the entity name in a sentence and determining the type of the identified entity name. The NER may be used to extract an important keyword from a sentence and understand the meaning of the sentence.

Speech act analysis is the task of analyzing the intention of an utterance. It is used to determine the intention of a user's speech, such as whether the user is asking a question, making a request, providing a response, or expressing an emotion.

Information such as a domain, an entity name, and a speech act may be used for at least one of the following actions: classifying the speaker's intended meaning, determining the slot, or generating a response to the speaker's speech utterance. Specifically, the NLU engine may segment the input sentence into morpheme units using a morphological analyzer, project the morphemes into a vector space, group the projected vectors to classify intents according to the input sentence, and extract other components corresponding to slots of intents in the input sentence as entities.

For example, if the input sentence is “Call Kim Cheol-soo,” the NLU engine tokenizes the input sentence into “Kim Cheol-soo,” “to,” “call,” “do,” and “please.” The NLU engine determines that the speaker's intended meaning of the input sentence is “making a call” based on the tokens. The slot for the speaker's intended meaning is “call target,” and in this case, the NLU engine may extract “Kim Cheol-soo” as a keyword.

In another example, if the input sentence is “Turn on the air conditioner,” the speaker's intended meaning is “air conditioner power on,” and the slot corresponding to the speaker's intended meaning is “temperature” and “fan speed.”

The data management unit 230 stores data such as the speaker's utterance pattern, speech speed, pronunciation characteristics, and average trailing silence length during speech. The data management unit 230 may optimize speech recognition performance based on personalized data for each speaker. The data management unit 230 maintains the length of the default trailing silence interval learned for each speaker and enables it to be used in determining the speech termination. The data management unit 230 may provide learning data for updating speech recognition and natural language processing models according to data on new speakers or environmental changes. The data management unit 230 transmits the morphological analysis results to the trailing silence adjusting unit 240.

The trailing silence adjusting unit 240 determines the end point of the input speech and dynamically adjusts the length of the trailing silence interval based on the type of the last word unit. The type of the last word unit may mean the type of the part of speech. In other words, the length of the trailing silence interval for the user is adjusted based on the type of the analyzed part of speech. The type of the analyzed part of speech may include at least one of a common noun, a proper noun, a dependent noun, a pronoun, a numeral, a determiner, an attributive adjective, an adverb, a particle, a connecting suffix, a terminal suffix, and a suffix. The trailing silence adjusting unit 240 determines whether the type of the part of speech of the last word unit in the user's utterance received from the data management unit 230 is a terminal suffix. When it is determined that the type of part of speech of the last word unit in the utterance received from the data management unit 230 is the terminal suffix, the trailing silence adjusting unit 240 may reduce the user's waiting time by shortening the length of the trailing silence interval of the user who has spoken by an offset by recognizing the intent to end a sentence. When it is determined that the type of part of speech of the last word unit in the received user's utterance is any one of the numeral, the connecting suffix, the attributive adjective, the adverb, the particle, and the suffix, the trailing silence adjusting unit 240 extends the length of the trailing silence interval of the user who has spoken by an offset, thereby increasing the user's waiting time.

When the type of the part of speech of the last word unit in the utterance is the common noun or the proper noun, the trailing silence adjusting unit 240 may compare it with a list of representative commands set in advance and then determine whether the probability that the last word unit will be followed by an additional word unit is higher than a critical probability. A representative command list refers to a set of commands and words defined in advance. In particular, the representative command list is a list referenced to determine whether a specific utterance may be recognized as a command. If the probability that the last word unit will be followed by an additional word unit is higher than the critical probability, the trailing silence adjusting unit 240 may extend the length of the trailing silence interval for the user by the offset. On the other hand, if the probability that the last word unit will be followed by an additional word unit is lower than the critical probability, the length of the trailing silence interval of the user who has spoken is maintained at its original state. The trailing silence adjusting unit 240 may adjust the length of the user's trailing silence interval depending on the situation. In other words, the trailing silence adjusting unit 240 may shorten, extend, or maintain the length of the trailing silence interval. Subsequently, the trailing silence adjusting unit 240 may determine whether an additional utterance is received within the adjusted trailing silence interval. When the additional utterance is received, the trailing silence adjusting unit 240 determines that the user's utterance is not terminated. On the other hand, when the additional utterance is not received, the trailing silence adjusting unit 240 determines that the user's utterance is terminated. The trailing silence adjusting unit 240 may apply a subdivided offset depending on the type of part of speech of the last word unit in the utterance. For example, when the adnominal case particle ‘of’ is recognized, there is a high probability that the proper noun or common noun will follow, so a longer offset may be applied compared to the adverbial case particle ‘to’. Further, when the connecting suffix ‘and’ is recognized, the length of the trailing silence interval may be extended further to increase the possibility of additional utterances.

Table 1 below is a morpheme table when a user utters ‘Set the temperature to 72 degrees.’

TABLE 1

| No. | Word unit | Form | Type |
|---|---|---|---|
| 1 | [symbol] | [symbol] | Common Noun |
| | (Temperature) | (Temperature) | |
| 2 | [symbol] (° C.) [symbol] | 22° C. | Numeral |
| | (to 72 degrees) | (72° F.) | |
| | | [symbol] | Dependent Noun |
| | | (degree) | |
| | | [symbol] | Adverbial case |
| | | (to) | marker |
| 3 | [symbol] | [symbol] | Verb |
| | (set) | (set) | |
| | | [symbol] | Connecting Suffix |
| | | (connecting suffix) | |
| 4 | [symbol] | [symbol] | Auxiliary predicate |
| | (give) | (give) | element |
| | | [symbol] | Terminal Suffix |
| | | (terminal suffix) | |

Referring to Table 1, a first word unit, “ [symbol] (temperature),” matches with the common noun. Since the probability that the last word unit will be followed by an additional word unit is higher than the critical probability, the trailing silence adjusting unit 240 may extend the length of the user's trailing silence interval by the offset. A second word unit “22 [symbol] (° C.) [symbol] (to 72 degrees)” has the last word unit as “ [symbol] (to)”. “ [symbol] (to)” is the adverbial case marker. Since the last type of the second word unit is the adverbial case marker, the trailing silence adjusting unit 240 may extend the length of the trailing silence interval by the offset. A third word unit “ [symbol] (set)” has the last word unit as “˜ [symbol] (connecting suffix)”. “˜ [symbol] ” is a connecting suffix. Since the last type of the third word unit is the connecting suffix, the trailing silence adjusting unit 240 may extend the length of the trailing silence interval by the offset. A fourth word, “ [symbol] (give),” has the last word as “ [symbol] (terminal suffix).” “ [symbol] ” is a terminal suffix. Since the last type of the fourth word unit is the terminal suffix, the trailing silence adjusting unit 240 may determine that the utterance is terminated and reduce the length of the trailing silence interval by the offset.

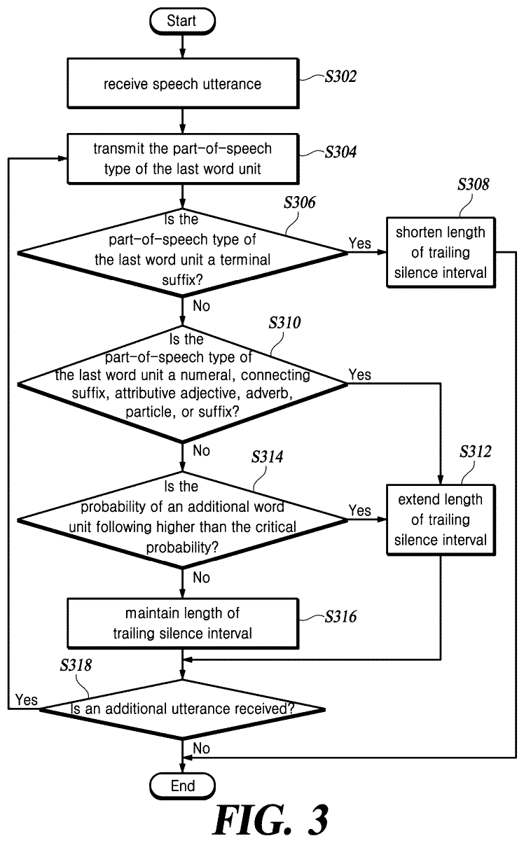

FIG. 3 is a flowchart illustrating the operation of the speech utterance termination detection device 10 according to an embodiment of the present disclosure.

The speech recognition input device 100 receives the speech utterance from the user in step S302. The speech recognition engine 210 receives the speech signal corresponding to the speaker's speech utterance. The natural language processing engine 220 may process the speech signal, extract information such as domains, entity names, and speech acts from an input sentence using, for example, the NLU engine, and extract the intent and slot based on the extracted result. Specifically, the NLU engine may segment the input sentence into morpheme units using the morphological analyzer, project the morphemes into the vector space, group the projected vectors to classify intents according to the input sentence, and extract other components corresponding to slots of intents in the input sentence as entities. In other words, the natural language processing engine 220 may analyze the part of speech of the last word unit in the user's utterance.

The data management unit 230 transmits the type of the last word unit in the user's utterance to the trailing silence adjusting unit 240 in step S304. Here, the type of the last word unit may mean the type of the part of speech. The type of the analyzed part of speech may include at least one of a common noun, a proper noun, a dependent noun, a pronoun, a numeral, a determiner, an attributive adjective, an adverb, a particle, a connecting suffix, a terminal suffix, and a suffix.

The trailing silence adjusting unit 240 determines whether the type of part of speech of the last word unit in the user's utterance received from the data management unit 230 is a terminal suffix, in step S306.

When it is determined that the type of part of speech of the last word unit in the utterance is the terminal suffix (Yes in S306), the trailing silence adjusting unit 240 may reduce the user's waiting time by shortening the length of the trailing silence interval of the user who has spoken by the offset by recognizing the intent to end a sentence, in step S308. When it is determined that the type of part of speech of the last word unit in the utterance is not the terminal suffix (No in S306), the trailing silence adjusting unit 240 determines whether the type of part of speech of the last word unit in the received user's utterance is any one of the numeral, the connecting suffix, the attributive adjective, the adverb, the particle, and the suffix, in step S310. When it is determined that the type of part of speech of the last word unit in the received user's utterance is any one of the numeral, the connecting suffix, the attributive adjective, the adverb, the particle, and the suffix (Yes in S310), the trailing silence adjusting unit 240 extends the length of the trailing silence interval of the user who has spoken by the offset, thereby increasing the user's waiting time, in step S312. When the type of the part of speech of the last word unit in the utterance is the common noun or the proper noun, the trailing silence adjusting unit 240 may compare the type of the part of speech of the last word unit with a list of representative commands set in advance and then determine whether the probability that the last word unit will be followed by an additional word unit is higher than a critical probability, in step S314 (No in S310). The representative command list refers to a set of commands and words defined in advance, and is a list referenced to determine whether a specific utterance may be recognized as a command. If the probability that the last word unit will be followed by an additional word unit is higher than the critical probability (Yes in S314), the trailing silence adjusting unit 240 may extend the length of the trailing silence interval for the user by the offset in step S312. On the other hand, if the probability that the last word unit will be followed by an additional word unit is lower than the critical probability (No in S314), the length of the trailing silence interval of the user who has spoken is maintained at its original state in step S316. The trailing silence adjusting unit 240 may adjust the length of the user's trailing silence interval depending on the situation. In other words, the trailing silence adjusting unit 240 may shorten, extend, or maintain the length of the trailing silence interval. Subsequently, the trailing silence adjusting unit 240 may determine whether an additional utterance is received within the adjusted trailing silence interval, in step S318. When the additional utterance is received (Yes in S318), the trailing silence adjusting unit 240 determines that the user's utterance is not terminated and the speech utterance termination detection device 10 continues to receive the additional utterance. On the other hand, when the additional utterance is not received (No in S318), the trailing silence adjusting unit 240 determines that the user's utterance is terminated and the speech utterance termination detection device 10 causes the processor 420 to recognize the end of the sentence. Once the end of the sentence is recognized, the processor 420 generates and processes the sentence, and transmits the processed sentence to, for example, vehicle control (i.e., to control the vehicle) or to control different hardware components/devices that may be controlled by the utterance of the user, e.g., navigation, messaging, and audio hardware systems in a vehicle.

FIG. 4 is a block diagram schematically illustrating a computing device that may be used to implement a method or apparatus according to an embodiment of the present disclosure.

The computing device 40 may include some or all of a non-transitory memory 400, a processor 420, a storage 440, an input/output interface 460, and a communication interface 480. The computing device 40 may be a stationary computing device such as a desktop computer or a server as well as a mobile computing device such as a laptop computer or a smart phone. The computing device 40 may include any specialized hardware accelerator capable of processing operations for an artificial intelligence model in an efficient manner. For example, the computing device 40 may include a graphic processing unit (GPU), a tensor processing unit (TPU), or a neural processing unit (NPU).

The memory 400 may store a program that causes the processor 420 to perform methods or operations according to various embodiments of the present disclosure. For example, the program may include a plurality of commands/computer-executable instructions executable by the processor 420. The above-described methods or operations may be performed by executing the plurality of commands/computer-executable instructions by the processor 420. The memory 400 may be a single memory or multiple memories. In this case, information required to perform the method or operation according to various embodiments of the present disclosure may be stored in the single memory or divided and stored in the multiple memories. When the memory 400 is composed of multiple memories, the multiple memories may be physically separated. The memory 400 may include at least one of volatile memory and non-volatile memory. The volatile memory includes SRAM (Static Random Access Memory) or DRAM (Dynamic Random Access Memory), and the nonvolatile memory includes flash memory.

The processor 420 may include at least one core capable of executing at least one command. The processor 420 may execute commands/computer-executable instructions stored in the memory 400. The processor 420 may be a single processor or multiple processors.

The storage 440 maintains stored data even when power supplied to the computing device 40 is cut off. For example, the storage 440 may include the non-volatile memory and may include storage media such as magnetic tape, optical disks, or magnetic disks. A program stored in the storage 440 may be loaded into the memory 400 before being executed by the processor 420. The storage 440 may store a file written in a programming language, and a program generated from the file by a compiler or the like may be loaded into the memory 400. The storage 440 may store data to be processed by the processor 420 and/or data processed by the processor 420.

The input/output interface 460 may provide an interface with an input device such as a keyboard or a mouse, and/or an output device such as a display device or a printer. A user may trigger execution of a program by the processor 420 through the input device and/or check the processing result of the processor 420 via the output device.

The communication interface 480 may provide access to an external network. The computing device 40 may communicate with other devices via the communication interface 480.

The disclosed embodiments of the present disclosure, by dynamically adjusting a trailing silence value based on the last part of speech of a word unit, prevent a speech recognition mode from terminating prematurely before a sentence is completed, thereby improving a speech recognition rate.

The technical effects of the present disclosure are not limited to the above-mentioned effects. Other effects not explicitly mentioned above should be clearly understood by those of ordinary skill in the art from the foregoing description.

The present disclosure provides a technical solution to improve speech recognition systems. By dynamically adjusting a trailing silence interval based on real-time analysis of part-of-speech information of a user's utterance, the system prevents premature termination of speech recognition and enhances recognition accuracy. The trailing silence adjustment is not a mere abstract idea or mental process but is implemented through specific hardware and software interactions within the speech recognition system. The technical effect of the present disclosure includes improved termination detection, reduced unnecessary wait times, and enhanced support for multi-intent utterances.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments may include implementations with one or more computer programs that are executable on a programmable system. The programmable system includes at least one programmable processor, which may be a special purpose or specially configured processor, coupled to receive and transmit data and instructions from and to a storage system, at least one input device, and at least one output device. Computer programs (also known as programs, software, software applications, or code) include computer-executable instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely a description of the technical idea of one embodiment of the present disclosure. In other words, those of ordinary skill in the art may appreciate that various modifications and changes may be made without departing from essential features of the various embodiments of the present disclosure. In other words, the sequence illustrated in the flowcharts/timing charts may be changed and one or more operations of the operations may be performed in parallel. Thus, flowcharts/timing charts are not limited to the temporal order.

Although various embodiments of the present disclosure have been described for illustrative purposes, those of ordinary skill in the art should appreciate that various modifications, additions, and substitutions are possible, without departing from the idea and scope of the claimed disclosure. Therefore, various embodiments of the present disclosure have been described for the sake of brevity and clarity. The scope of the technical idea of the present embodiments is not limited by the illustrations. Accordingly, one of ordinary skill in the art would understand that the scope of the claimed disclosure is not to be limited by the above described embodiments but by the claims and equivalents thereof.

What is claimed is:

1. A computer implemented method for determining whether a speech utterance is terminated, the method comprising:
receiving an utterance of a user;
dynamically adjusting a length of a trailing silence interval for the user based on a type of last word unit in the utterance of the user; and
determining whether the utterance of the user is terminated based on whether an additional utterance is received within the adjusted trailing silence interval.

2. The method of claim 1, wherein dynamically adjusting the length of the trailing silence interval comprises shortening the length of the trailing silence interval based on the last word unit being a terminal suffix.

3. The method of claim 1, wherein dynamically adjusting the length of the trailing silence interval comprises extending the length of the trailing silence interval based on the last word unit being any one of a numeral, a connecting suffix, an attributive adjective, an adverb, a particle, and a suffix.

4. The method of claim 1, wherein dynamically adjusting the length of the trailing silence interval comprises extending the length of the trailing silence interval based on a probability that the last word unit will be followed by an additional word unit being greater than a critical probability.

5. The method of claim 1, wherein determining whether the utterance of the user is terminated comprises determining that the utterance of the user is not terminated based on an additional utterance being received within the adjusted trailing silence interval.

6. The method of claim 1, wherein determining whether the utterance of the user is terminated comprises determining that the utterance of the user is terminated based on an additional utterance not being received within the adjusted trailing silence interval.

7. An apparatus comprising:
at least one memory configured to store computer-executable instructions; and
at least one processor configured to execute the computer-executable instructions to:
receive an utterance of a user;
dynamically adjust a length of a trailing silence interval for the user based on a type of a last word unit in the utterance of the user; and
determine whether the utterance of the user is terminated based on an additional utterance being received within the dynamically adjusted trailing silence interval.

8. The apparatus of claim 7, wherein to dynamically adjust the length of the trailing silence interval, the processor is further configured to shorten the length of the trailing silence interval based on the last word unit being a terminal suffix.

9. The apparatus of claim 7, wherein to dynamically adjust the length of the trailing silence interval, the processor is further configured to extend the length of the trailing silence interval based on the last word unit being any one of a numeral, a connecting suffix, an attributive adjective, an adverb, a particle, and a suffix.

10. The apparatus of claim 7, wherein to dynamically adjust the length of the trailing silence interval, the processor is further configured to extend the length of the trailing silence interval based on a probability that the last word unit will be followed by an additional word unit being greater than a critical probability.

11. The apparatus of claim 7, wherein to determine whether the utterance of the user is terminated, the processor is further configured to determine that the utterance of the user is not terminated based on an additional utterance being received within the adjusted trailing silence interval.

12. The apparatus of claim 7, wherein to determine whether the utterance of the user is terminated, the processor is further configured to determine that the utterance of the user is terminated based on an additional utterance not being received within the adjusted trailing silence interval.
